(19) United States
(12) Patent Application Publication
(10) Pub. No.: US 2009/0295852 A1
(43) Pub. Date: Dec. 3, 2009

(54) ACOUSTIC INK JET RECORDER

(75) Inventor: Shuichi Yamasaki, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/473,576

(22) Filed: May 28, 2009

(30) Foreign Application Priority Data
May 29, 2008 (JP) 2008-140703

(51) Int. Cl. B41J 29/38; B41J 2/04

(52) U.S. Cl. 347/9; 347/54

(57) ABSTRACT

An ink layer block (7) including ink droplet jetting nozzles is provided so as to be movable relative to each of a plurality of ultrasonic generation heads (1). The ink layer block (7) also includes two or more different ink layers (4, 5). There are a plurality of printing modes. When one printing mode is selected and set, the ink layer block (7) is moved such that a corresponding ink layer is moved to an associated head. Then, the ink in that ink layer is jetted out as droplets onto a recording target by ultrasonic waves generated by the head, thereby recording an image (FIG. 1).

### CROSS-REFERENCE TO RELATED APPLICATION

This application is based upon and claims the benefit of priority form the prior Japanese Patent Application No. 2008-140703, filed May 29, 2008, the entire contents of which are incorporated herein by reference.

### BACKGROUND OF THE INVENTION

1. Field of the Invention

The present invention relates to acoustic ink jet recorders capable of using a plurality of kinds of inks.

2. Background Art

Ink jet recorders having various structures are conventionally known. Especially many acoustic ink jet recorders have been proposed which jet out ink droplets, using an acoustic force produced by focusing ultrasonic waves through an acoustic lens, for example, as disclosed in JP 2002-166541, JP 2000-108336, and JP-H 07-068769.

In addition to the acoustic ink jet type, these ink jet recorders further include ones of thermal and piezoelectric ink jet types. All the above-mentioned ink jet recorders have an ink reservoir and an ink droplet creating energy generation head which are fixed to each other; that is, the ink reservoir and head are not separated movable with respect to each other.

When color ink jet printers, developed by those techniques, perform monochromatic printing, only a black head and a black ink are used and other color heads and other magenta and cyan inks, etc. are not used during the printing.

Of course, a print ink for low-quality paper such as recycled paper is different from that for photographic paper. When one kind of print ink should be exchanged by another, the head itself should be exchanged by a corresponding one, or otherwise this latter head must be juxtaposed beforehand. Alternatively, the printer itself is required to be exchanged.

However, these energy generation heads are costly and the number of those heads should be reduced as much as possible from the standpoint of cost performance.

### SUMMARY OF THE INVENTION

It is therefore an object of the present invention to provide an unprecedented high-speed high-performance acoustic ink jet recorder where color print heads also are used for monochromatic printing without increasing the number of costly heads.

It, is another object of the present invention to provide an acoustic ink jet recorder or printer where a common head is used for a plurality of kinds of recording inks.

In order to achieve the above objects, one aspect of the present invention is to provides an acoustic ink jet recorder comprising: an acoustic ink jet recorder comprising: an acoustic head having a plurality of acoustic energy generation elements arranged in a line each generating acoustic energy for a respective one of pixels to be recorded; a movable ink layer holder which holds a plurality of kinds of ink layers so as to dispose a selected one of the plurality of kinds of ink layers over the acoustic head; and head drive means for driving the acoustic head in a mode corresponding to the selected kind of ink layer so as to generate acoustic energy, thereby causing the selected kind of ink layer to record image data on a recording medium.

The acoustic ink jet recorder may further comprise: a plurality of such acoustic heads. The recorder may have a settable first mode where all the plurality of acoustic heads record image data, using a first kind of ink layer; and a settable second mode where all the plurality of acoustic heads record image data, using at second kind of ink layer. The acoustic ink jet recorder may further comprise: data feeding means for dividing image data and for providing the divided data to the corresponding acoustic heads; head driving means for driving the plurality of acoustic heads sequentially based on the fed data; and conveying means for conveying the recording medium such that the respective acoustic heads can scan the recording medium in synchronism with their respective recording operations.

### BRIEF DESCRIPTION OF THE DRAWINGS

The accompanying drawings, which are incorporated in and constitute a part of the specification, illustrate presently preferred embodiments of the present invention and, together with the general description given above and the detailed description of the preferred embodiments given below, serve to explain the principles of the present invention in which:

FIG. 1 schematically illustrates an acoustic ink jet recorder which can take any one of two positions A and B as one embodiment of the present invention.

FIG. 2 shows one example of an ultrasonic generator of the inventive acoustic ink jet recorder.

FIG. 3 illustrates a concrete example of use of the inventive acoustic ink jet recorder.

FIG. 4 illustrates an example of use of a second embodiment of the inventive acoustic ink jet recorder.

FIG. 5 illustrates timing of ultrasonic wave emissions of color ink droplets in a color recording mode.

FIG. 6 illustrates head driving in a monochromatic printing mode.

FIG. 7 is a flowchart of operation of the ink jet recorder to be performed from issue of a print command to a start of the print.

FIG. 8 illustrates a desired image of data to be printed.

FIG. 9 illustrates parts of the FIG. 8 data divided and arranged for monochromatic color printing.

### DETAILED DESCRIPTION OF THE PREFERRED EMBODIMENTS

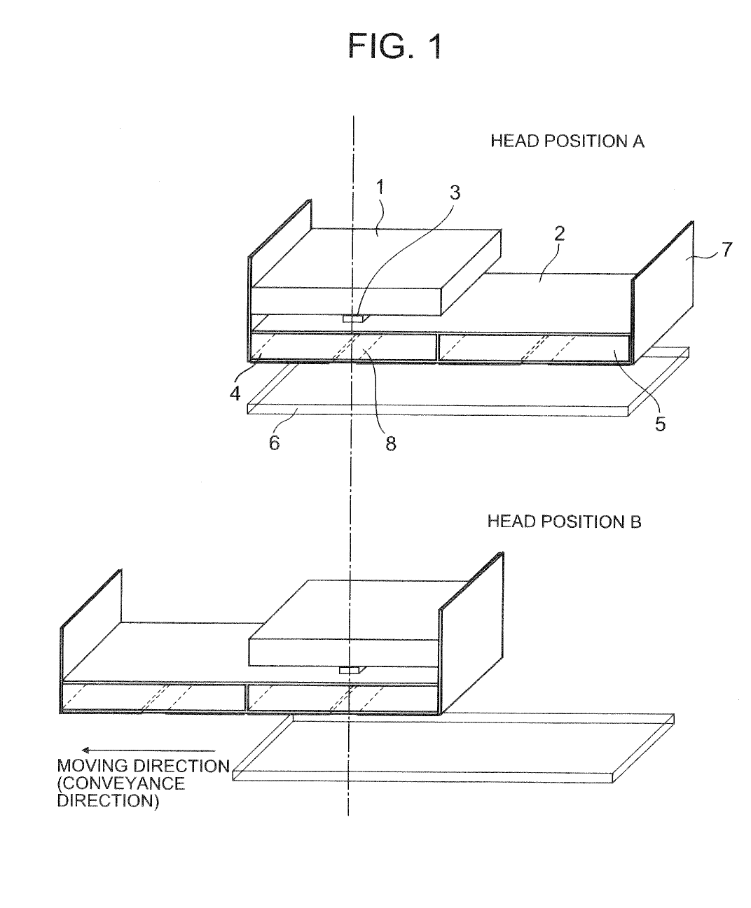

FIGS. 1-3 illustrate one example of the acoustic ink jet, recorder as one embodiment of present invention. This recorder takes the form of a line-type ink jet printer. The recorder includes an ultrasonic head 1 and an ink layer block 7 movable relative to the head and including first and second ink layers 4 and 5. The head 1 includes a line-like ultrasonic generator 3.

In FIG. 1, the ink layer block 7 is arranged to move relative to the head 1 so as to stop at, a selected once of positions A and B. At the position A, the first ink layer 4 is placed under the line-like ultrasonic generator 3. The ultrasonic generator 3 is then driven so as to generate ultrasonic waves which jets out as droplets the ink in that layer onto a recording target (or paper) 6 through a nozzle (not shown) of the ink layer block 7. Reference numeral 2 denotes a place where a coupling member (not shown) is placed.

At the position B, the ultrasonic generator 3 is similarly driven so as to generate ultrasonic waves to jet, out and deposit as droplets the ink in the second ink layer 5 onto the recording target 6.

In other words, the two different ink layers 4 and 5 are moved such that a selected one of them is moved to below the ultrasonic generator 3 and then ink drops are jetted out from the selected ink layer onto the recording target 6. In FIG. 1, reference numeral 8, denotes a slit through which the ink droplets are jetted out onto the recording target 6.

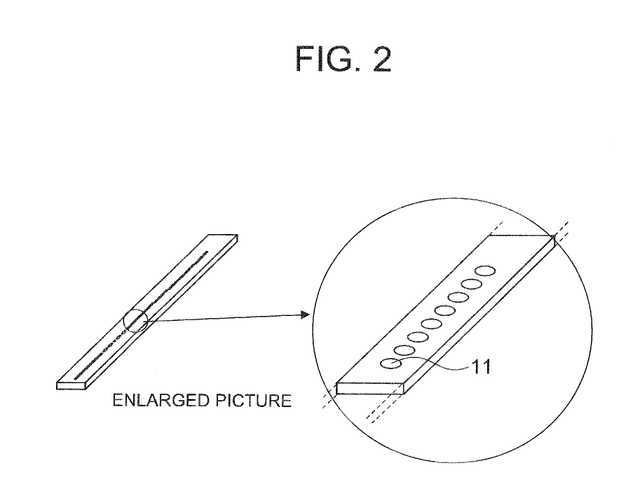

FIG. 2 illustrates one example of the line like ultrasonic generator 3, which includes a cell unit of cells 11 arranged in a line, each cell of which includes a piezoelectric material such as PZT or ZnO held between a pair of electrodes (not shown). A burst wave drive signal is applied across the pair of electrodes for each cell to cause ultrasonic vibrations in the thickness direction of the cell, thereby causing the ink in the ink layer to be jetted out as droplets onto the recording target.

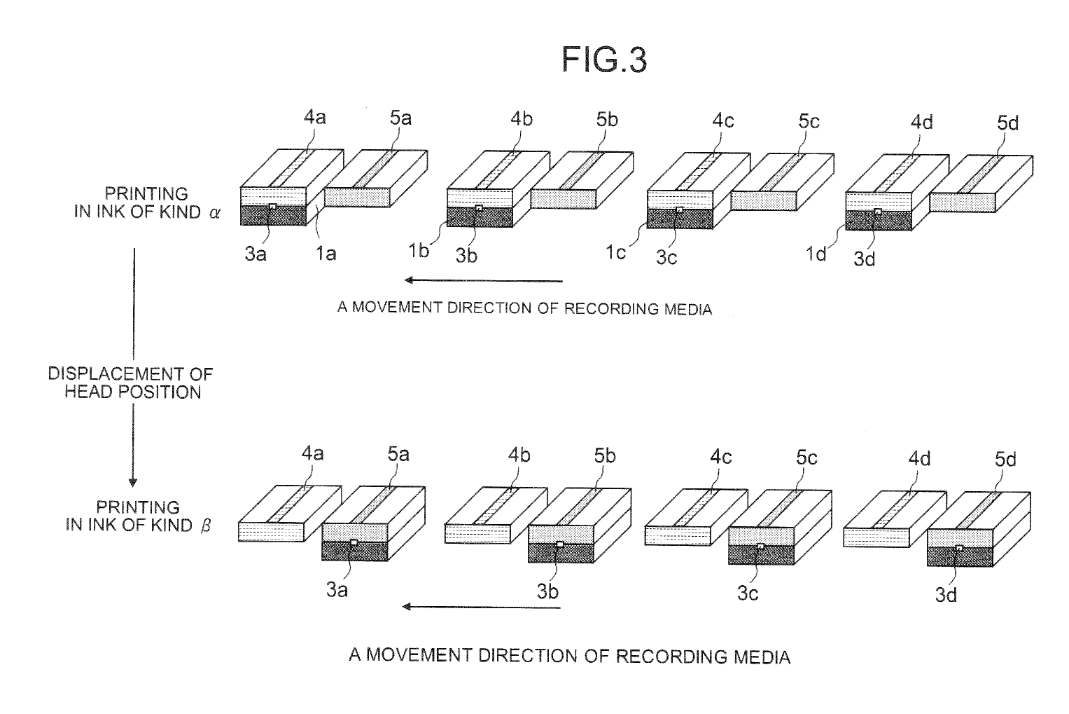

FIG. 3 illustrates an example of use of the inventive device. For convenience, the arrangement of FIG. 3 is shown in an upside down form of that of FIG. 1; thus, in FIG. 1, droplets are jetted out downward whereas in FIG. 3 they are jetted out upward.

FIG. 3 also illustrates that in an upper position therein a plurality of first ink layers 4a, 4b, 4c and 4d of an ink kind α are disposed above the ultrasonic generators 3a, 3b, 3c and 3d, respectively, so as to jet out ink droplets upwards and that in a lower position therein a plurality of second ink layers 5a, 5b, 5c and 5d of an ink kind β are disposed above the ultrasonic generators 3a, 3b, 3c and 3d so as to jet out ink droplets upward.

The inks of kinds α and β should be selected so as to be different; that is, for example, dyestuff and pigment; or water-soluble and oil-based inks, respectively.

As described above, the ink layer block 7, which includes ink droplet emission nozzles (not shown) and at least two ink layers 4 and 5, is movable relative to the head 1. Two or more kinds of ink layers such as shown by 4 and 5 are provided for each head. A plurality of different printing modes are stored such that any one of the modes can be read and set. When one of the different printing modes is selected, the ink layers 4 and 5 are moved such that an associated one of the ink layers 4 and 5 is selected and moved to above the ultrasonic generator 3. Then, the ultrasonic generator 3 is driven such that the ink in that ink layer is jetted out as droplets from the associated ink layer.

In other words, the ink layer 4 or 5 is selected in accordance with a selected printing mode. Thus, in the same printer (or ink jet recorder) a different tone print is obtained by selecting and using one of water-soluble and oil-based print inks or otherwise by selecting an ink whose viscosity is determined in accordance with the quality of printing paper used.

Thus, the present invention provides a high-speed acoustic ink jet recorder with color heads usable also for monochromatic printing, which has not been provided heretofore. The recorder is simple in structure and not required to increase the number of costly heads for monochromatic printing.

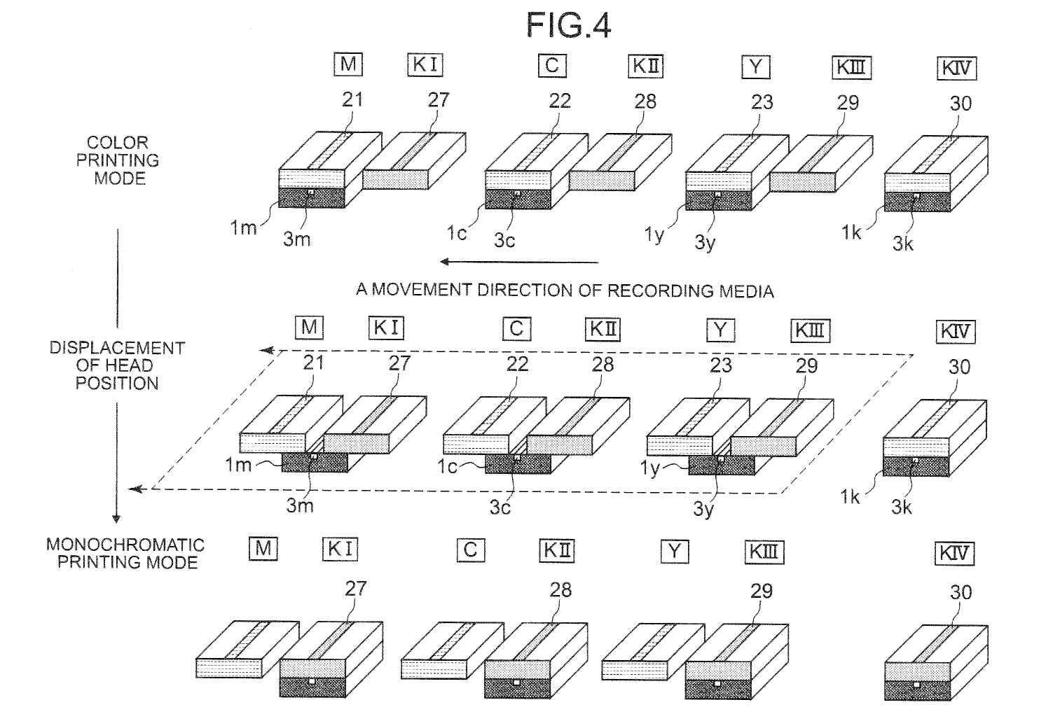

FIGS. 4-9 relates to a second embodiment of the acoustic ink jet recorder. Similarly to the first embodiment, also in this embodiment, an ink layer block such as shown by 7 in FIG. 1 is provided, but for sake of simplification, only a plurality of kinds of ink layers and a like number of ultrasonic heads of the ink layer block are shown. The ink layer block is arranged to be moved by a drive mechanism (not shown) so as to stop at a selected one of two positions such as shown by A and B in FIG. 1. At each of the two positions, the ultrasonic head 1 can generate ultrasonic waves, which jet out as droplets the ink in the associated ink layer through the coupling medium onto the recording target, which may be printing paper or an OHP film, for example.

Similarly to the first embodiment, two kinds of ink layers of the second embodiment are provided movable relative to each of ultrasonic heads 1 such that a selected one of the ink layers is moved to over an associated ultrasonic generator 3, which is then driven so as to generate ultrasonic waves thereby causing ink drops to be jetted out from the selected ink layer onto the recording target. A slit such as shown by 8 in FIG. 1 is also provided in position although not shown.

The ultrasonic generator 3 of the second embodiment is the same in structure and function as that of FIG. 1. FIG. 4 illustrates an example of use of the second embodiment. As in FIG. 3, the arrangement of FIG. 4 is in an upside down form of that of FIG. 1; that is, in FIG. 1, droplets are jetted out downward whereas in FIG. 4 they are jetted out upward.

In the second embodiment, in the color printing mode, magenta (M), cyan (C), yellow (Y) and black (K) ink layers 21, 22, 23 and 30 are disposed over ultrasonic wave generators 3m, 3c, 3y and 3k, respectively, with black ink layers 27, 28 and 29 disposed by the respective sides of the color ink layers 21, 22 and 23.

In a monochromatic printing mode, all the six color ink layers other than the black ink layer 30 move (leftward in FIG. 4) such that the black ink layers 27, 28, 29 and 30 are disposed over the corresponding ultrasonic generators 3m, 3c, 3y and 3k. Thus, black ink droplets alone are jetted out from the black ink layers 27-30 onto the recording target while in the color printing mode the four color (M, C, Y and K) ink droplets are jetted out.

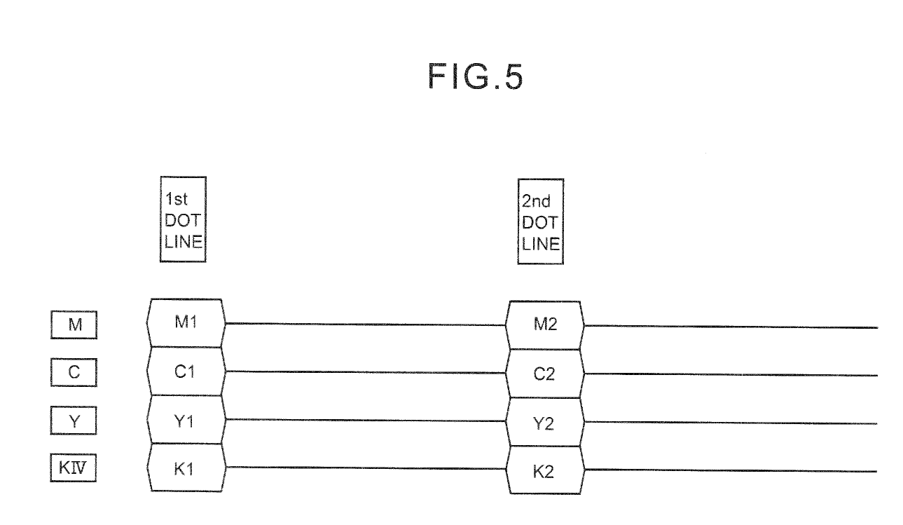

FIG. 5 illustrates timing of ultrasonic wave emissions in the color printing mode. In operation, it, is assumed that the recording target is printing paper and that the effective record width of each of the four-color ultrasonic heads is equal to that of the printing paper. As shown in FIG. 4, the four-color ultrasonic heads 1m, 1c, 1y and 1k are disposed in a feeding direction of the printing paper as shown by an arrow in an upper position in FIG. 4.

The timing points when the respective heads 1m, 1e, 1y and 1k are actually driven are different depending on positions where they are disposed. For sake of simplification, these differences are not reflected herein. Therefore, it is assumed in FIG. 5 that the four color heads are simultaneously driven to record four color lines superimposed in the same line on the recording paper.

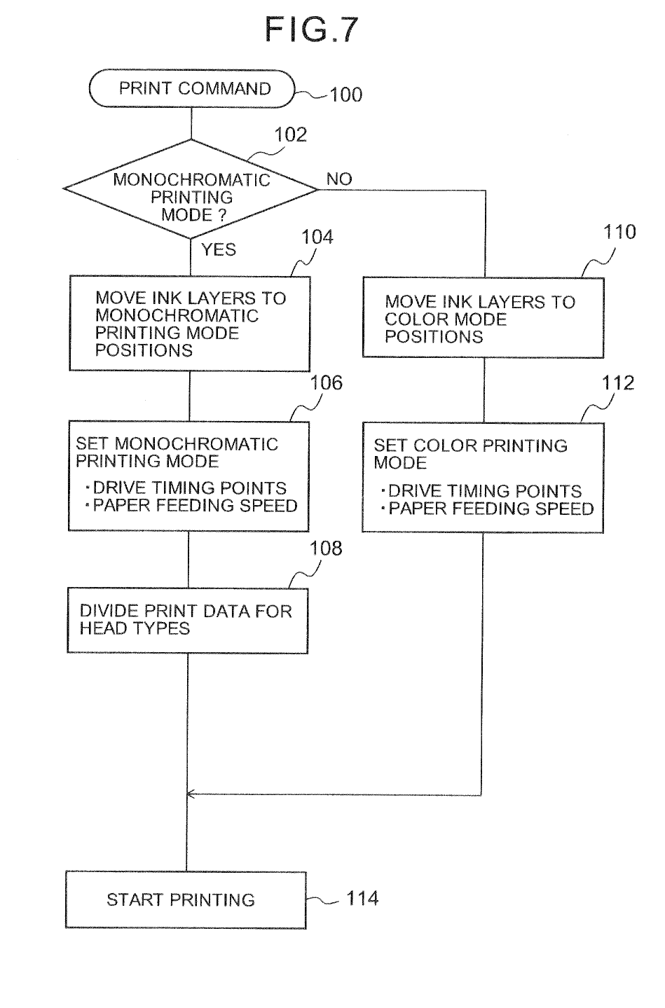

FIG. 7 is a flowchart of a process in which after a host controller (not shown) issues a print command, a decision is made whether the printing should be made in the monochromatic printing mode or in the color printing mode, and then such printing is prepared.

More particularly, in this flowchart, when a print command is given (step 100), a decision is made which of the monochromatic printing and color printing modes the command requires to set (step 102). If it requires the monochromatic printing mode to be set, a black ink layer is disposed over a monochromatic printing position or each of the ultrasonic generators (step 104). Then, the monochromatic printing drive mode is set, timing points when the respective ultrasonic generators are driven and the feeding speed of the printing paper are set (step 106). Then, print data is divided for and forwarded to the respective heads (step 108), thereby starting the printing (step 114). If the command requires the color printing mode to be set (step 102), the same or different color ink layers are disposed over respective color printing positions or the respective ultrasonic generators (step 110). Then, the color printing drive mode is set; timing points when the respective ultrasonic generators are driven and the feeding speed of the printing paper are set (step 112). Then, the printing starts (step 114).

In the color printing mode, the four different-color (M, C, Y and K) ultrasonic heads are simultaneously driven such that four color recordings are synchronized, thereby printing data M1, C1, Y1 and K1 in a first dot line on the recording paper. Then, at the position where the paper is conveyed for one dot size, the heads M, C, Y and K are driven to print data M2, C2, Y2 and K2 in a second dot line on the recording paper. The feeding speed of the printing paper is dependent on the driving cycle of the heads. Generally the feeding speed of the printing paper is set such that the driving cycle is minimum, but cannot be set so as to exceed the maximum frequency (or minimum driving cycle) of ink droplet ejection.

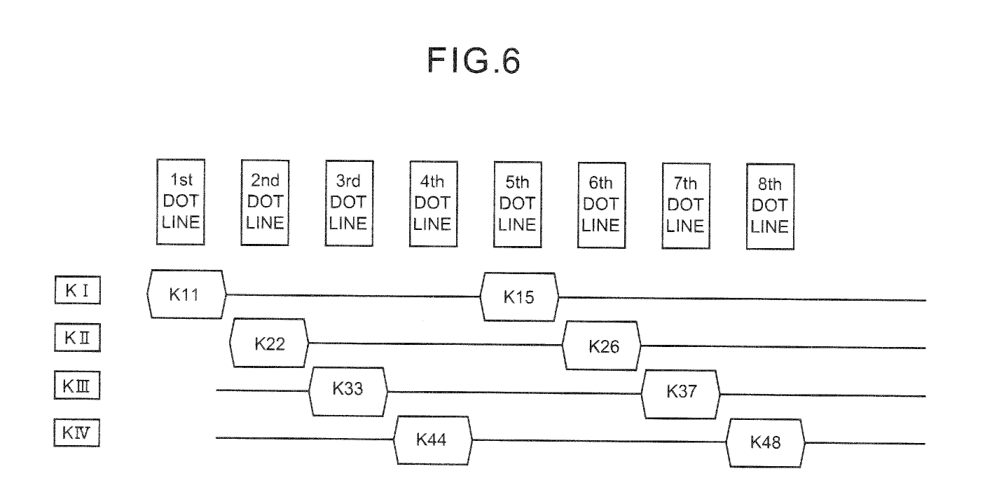

FIG. 6 illustrates head driving in the monochromatic printing mode. In this ease, the paper feeding speed is set to four times that set in the color printing mode. A first dot line is printed with line data K11 in a black ink layer by in ultrasonic head at, a position K1; a second dot line is printed with line data K22 in a black ink layer by an ultrasonic head at a position KII; a third dot line is printed with line data K33 in a black ink layer by an ultrasonic head at a position KIII; a fourth dot line is printed with line data K44 in a black ink layer by an ultrasonic head at a position KIV; a fifth (lot line is printed with line data K15 in a black ink layer by the head at the position K1; . . . .

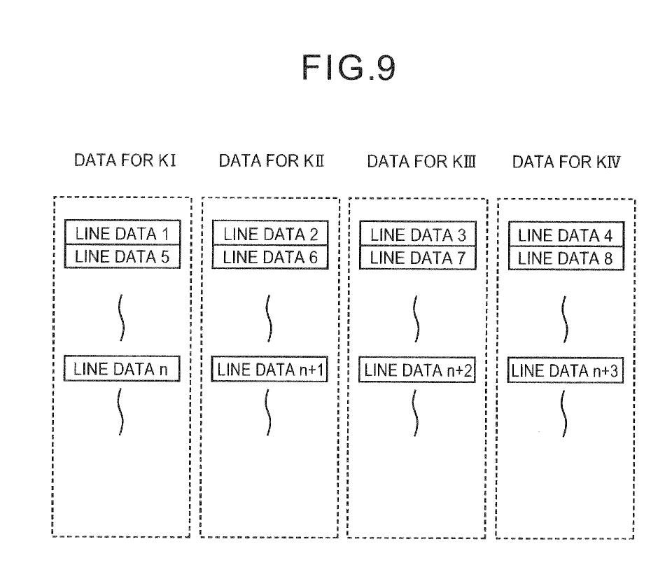

At this time, the respective data are distributed to the corresponding heads, as shown in FIG. 9. As in the first embodiment, the four heads are arranged in the paper feeding direction, and the timing points when the respective head are actually driven are different depending on their positions. For sake of simplification, such differences are not reflected herein. Thus, when in FIG. 6 the four heads are driven sequentially at their respective timing points one different from another by a time for one dot line, four black lines are recorded sequentially at positions one adjacent to another on the recording paper.

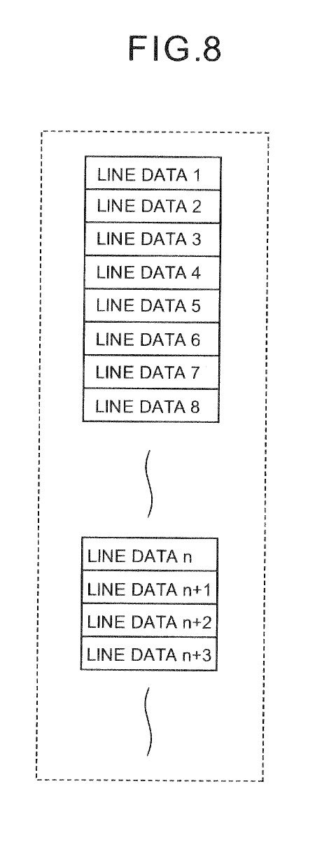

FIG. 8 illustrates a desired image of data to be printed. In FIG. 8, the horizontal length of each line data corresponds to the horizontal length of the ultrasonic generator which prints that line data and the printing paper is fed upward or in the direction in which the respective line data 1, 2, 3, . . . are arranged.

FIG. 9 illustrates that; in the monochromatic printing mode the data of FIG. 8 is separated into four data files, which are forwarded to and printed by corresponding heads. Thus, in the arrangement of FIGS. 4 and 6, monochromatic printing can be performed at four times the printing speed employed in the FIG. 8 printing without increasing the driving frequency of the respective heads.

According to the above-mentioned arrangements of the first and second embodiments, a plurality of kinds of ink layers are provided for each of the heads. The plurality of kinds of ink layers contain at least one same color (for example black) ink. When a same-ink droplet jetting mode is set, print data is divided for the respective heads. At this time, the feeding speed of the print target can be set, and the timing points for driving the respective heads can be set. Thus, when the number of heads is n, the heads can cooperate to print at n times the maximum printing speed of each head. Among the plurality of kinds of ink layers, a required ink layer is moved depending on a respective printing mode set.

That is, the inventive recorder has an ultrasonic emission timing mode in which respective timing points are set when the ultrasonic generators are driven to generate ultrasonic waves. That is, the recorder has the function of setting timing points when the heads generate ultrasonic waves depending on respective associated ink layers; the function of dividing print data in accordance with a printing mode set; and the function of setting the feeding speed of the printing target depending on the printing mode set. Thus, the same head is usable for printing image data in a plurality of kinds of ink layers. Thus, many different kinds of inks are easily usable in the single printer.

In the present invention, the ultrasonic heads are used as the recording heads, and the plurality of kinds of ink layers are disposed movable relative to each recording head through an ultrasonic transmission medium. Thus, ink layers used can easily replaced in a short time by other desired ones as requested. Therefore, a wide variety of records made in various combinations of different kinds of ink colors or materials can be provided easily and rapidly.

If the inks in the ink layers in the above-mentioned embodiments are replaced with living-body organic liquids for forming biochips, with liquids for printing or recording patterns on circuit boards or with EL material liquids for forming patterns on circuit boards, the embodiments can contribute to the formation of biochips and circuit patterns on those circuit boards.

Various modifications and changes may be made thereunto without departing from the broad spirit and scope of this invention. The above-described embodiments are intended to illustrate the present invention not; to limit the scope of the present invention. The scope of the present invention is shown by the attached claims rather than the embodiments. Various modifications made within the meaning of an equivalent of the claims of the invention and within the claims are to be regarded to be in the scope of the present invention.

What is claimed is:

1. An acoustic ink jet recorder comprising:
an acoustic head having a plurality of acoustic energy generation elements arranged in a line each generating acoustic energy for a respective one of pixels to be recorded;
a movable ink layer holder which holds a plurality of kinds of ink layers so as to dispose a selected one of the plurality of kinds of ink layers over the acoustic head; and
head drive means for driving the acoustic head in a mode corresponding to the selected kind of ink layer so as to generate acoustic energy thereby causing the selected kind of ink layer to record image data on a recording medium.

2. The acoustic ink jet recorder of claim 1, further comprising:
a plurality of such acoustic heads; and wherein:
the recorder has a settable first mode where all the plurality of acoustic heads record image data, using a first kind of ink layer; and a settable second mode where all the plurality of acoustic heads record image data, using a second kind of ink layer; and further comprising:
data feeding means for dividing image data and for providing the divided data to the corresponding acoustic heads;
head driving means for driving the plurality of acoustic heads sequentially based on the fed data; and
conveying means for conveying the recording medium such that the respective acoustic heads can scan the recording medium, in synchronism with their respective recording operations.

3. The acoustic ink jet recorder of claim 2 wherein the first and second kinds of ink layers contain dyestuff- and pigment-based inks, respectively.

4. The acoustic ink jet recorder of claim 2, wherein the first and second kinds of ink layers contain water-soluble and oily inks, respectively.

5. The acoustic ink jet recorder of claim 1, further comprising:
a plurality of such acoustic heads; and wherein:
the recorder has a settable first mode where the plurality of acoustic heads record image data, using respective different kinds of ink layers; and a settable second mode where the plurality of acoustic heads record image data, using a same kind of ink layer; and further comprising: when the second mode is set,
data feeding means for dividing image data and for providing the divided data to the respective acoustic heads; and
conveying means for conveying the recording medium such that the respective acoustic heads can scan the recording medium at a speed n times that of the recording medium conveyed in the first mode where n is the number of line heads which records image data on the recording medium in the same kind of ink layer.

6. The acoustic ink jet recorder of claim 1, further comprising:
a plurality of such acoustic heads; and wherein:
the recorder has a settable first mode where the plurality of acoustic heads record image data, using respective different color ink layers and a settable second mode where the plurality of acoustic heads record image data, using a same color ink layer; and
when the first mode is set, data feeding means for dividing image data into respective different color data and for providing the divided color data to the corresponding acoustic heads for recording purpose;
when the second mode is set, data feeding means for dividing image data for the respective acoustic heads and for providing the divided data to the respective acoustic heads; and conveying means for conveying the recording medium such that the respective acoustic heads can scan the recording medium at a speed n times that of the recording medium carried in the first mode where n is the number of acoustic heads which records image data on the recording medium in the same kind of ink layer.

7. The acoustic ink jet recorder of claim 6, wherein when the first mode is set, colors involving the different color ink layers are yellow, magenta, cyan and black, and when the second mode is set, a color involving the same color is black.
